(19) United States
(12) Patent Application Publication
(10) Pub. No.: US 2014/0100934 A1
(43) Pub. Date: Apr. 10, 2014

(54) ADVERTISING SYSTEM AND ADVERTISING METHOD

(71) Applicant: YAHOO JAPAN CORPORATION, Tokyo (JP)

(72) Inventors: Tomohito TAKUSARI, Tokyo (JP); Hiromoto ONE, Tokyo (JP)

(73) Assignee: YAHOO JAPAN CORPORATION, Tokyo (JP)

(21) Appl. No.: 14/016,433

(22) Filed: Sep. 3, 2013

(30) Foreign Application Priority Data
Oct. 5, 2012 (JP) 2012-223105

(51) Int. Cl. G06Q 30/02

(52) U.S. Cl. CPC G06Q 30/0225
USPC 705/14.26

(57) ABSTRACT

In a display device 11, a receiving unit 20 receives delivered information including an advertisement of a product and code information to be provided to a store of an advertiser advertising the product to receive an incentive reward, a display unit 21 displays the advertisement included in the received delivered information, and a short-distance communication unit 22 readably provides the code information included in the received delivered information. A portable terminal device 12 reads the provided code information via a short-distance communication unit 53 that can read and write code information. In a store device 13 receives the code information using a short-distance communication unit 81 and offers an incentive reward when the code information is received.

### CROSS-REFERENCE TO RELATED APPLICATIONS

The present application claims priority to and incorporates by reference the entire contents of Japanese Patent Application No. 2012-223105 filed in Japan on Oct. 5, 2012.

### BACKGROUND OF THE INVENTION

1. Field of the Invention

The present invention relates to an advertising system and an advertising method.

2. Description of the Related Art

Conventionally, various products are advertised using broadcast content of commercial messages or television shows in the mass media such as a television. There are proposed techniques that a user can purchase a product by transmitting a purchase request and making payment with electronic money when the user desires to purchase the product viewed in broadcast content (for example, see Japanese Patent Application Laid-open No. 2008-305069 and Japanese Patent Application Laid-open No. 2011-150581).

When the user purchases a product viewed in broadcast content, sometimes the user dislikes the delivered product and returns it. Many users thus prefer to purchase a product after checking actual the product in person. However, when a user visits a store that handles the actual product and purchases the product, it is difficult, in the store side, to recognize whether the purchase of the product is led by effect of the advertisement in broadcast content. Then, for example, there is human-induced service that the user tells that the user viewed the advertisement in a show at the store to receive a discount. However, since it is not certain that the user actually viewed the advertisement in the show, the store may unfairly discount the price.

### SUMMARY OF THE INVENTION

It is an object of the present invention to at least partially solve the problems in the conventional technology.

According to one aspect of an embodiment of the present invention, an advertising system includes a portable terminal device configured to read and output information and a store device configured to receive the information output from the portable terminal device, wherein the portable terminal device comprises: a retention unit that reads and retains a code information output from a display device that displays an advertisement of a product included in delivered information and outputs the code information which can identify the advertisement included in the delivered information; and an output unit that outputs the code information when being communicable with the store device, and the store device comprises: a determination unit that receives the code information output from the portable terminal device and determines whether the advertisement identified by the code information is a certain advertisement; and an adding unit that offers an incentive reward to a user of the portable terminal device when the determination result by the determination unit is that it is a certain advertisement.

According to another aspect of an embodiment of the present invention, an advertising method executed by a portable terminal device configured to read and output information and a store device configured to receive the information output from the portable terminal device, comprising the steps of: the method includes: in the portable terminal device, reading and retaining the code information output from a display device that displays an advertisement of a product included in delivered information and outputs code information which can identify the advertisement included in the delivered information, and outputting the retained code information when communicable with the store device, and in the store device, receiving the code information output from the portable terminal device and determines whether the advertisement identified by the received code information is a certain advertisement, and offering an incentive reward to a user of the portable terminal device when the determination result is that it is the certain advertisement.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram systematically illustrating an entire configuration of a system according to a first embodiment;

FIG. 2 is a diagram illustrating an example of a functional configuration of a display device according to the first embodiment;

FIG. 3 is a diagram illustrating an example of a functional configuration of a portable terminal device according to the first embodiment;

FIG. 4 is a diagram illustrating an example of a selecting screen according to the first embodiment;

FIG. 5 is a diagram illustrating an example of a functional configuration of a store device according to the first embodiment;

FIG. 6 is a diagram illustrating an example of a data configuration of incentive reward information according to the first embodiment;

FIG. 7 is a sequence diagram illustrating a processing flow when the system according to the first embodiment delivers an advertisement and a user who viewed the advertisement purchases a product; and

FIG. 8 is a diagram illustrating an example of a functional configuration of a portable terminal device according to a second embodiment.

### DETAILED DESCRIPTION OF THE PREFERRED EMBODIMENTS

Embodiments to embody an advertising system and an advertising method according to the present invention (hereinafter referred to as “embodiments”) will be described in detail with reference to the drawings. It is noted that the present invention is not limited by the embodiments.

### First Embodiment

1-1. System Configuration

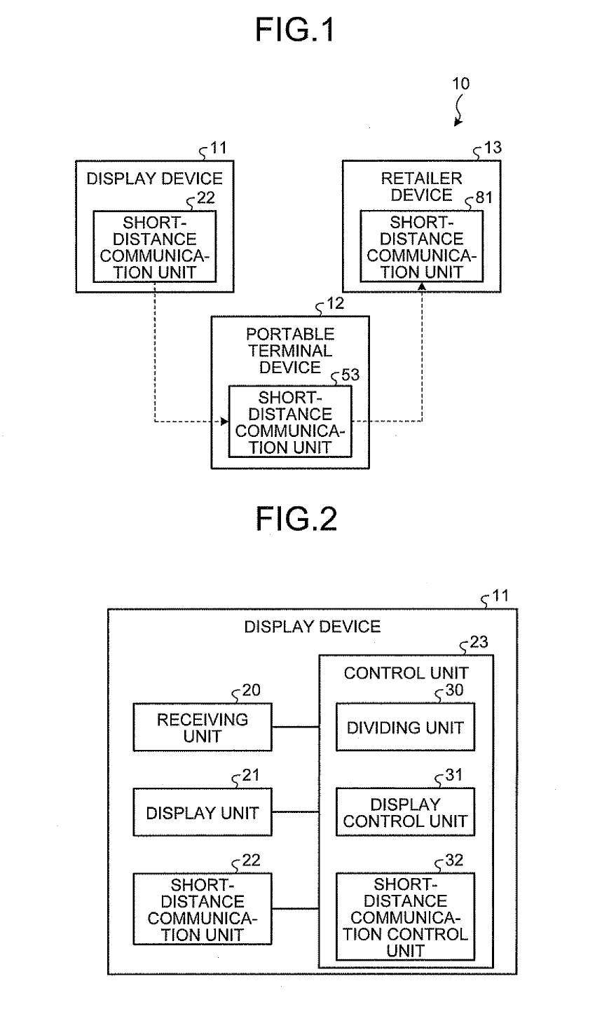

A first embodiment will be described. FIG. 1 is a diagram schematically illustrating an entire configuration of a system according to the first embodiment. As illustrated in FIG. 1, a system 10 includes a display device 11, a portable terminal device 12, and a store device 13. Here, although the system 10 includes the single display device 11, the single portable terminal device 12, and the single store device 13 in the example of FIG. 1, the disclosed system is not limited to this example and may include any number of display devices 11, portable terminal devices 12, or store devices 13.

The display device 11 is a device for displaying delivered (including broadcast) information, which is a television or a digital signage for displaying an advertisement in the street, for example. To the display device 11, various information is delivered. For example, to the display device 11, delivered information including an advertisement of a product and code information that offers an incentive reward when it is provided to a store of an advertiser advertising the product is delivered. The information can be delivered by cable or wirelessly to the display device 11. For example, when the display device 11 is a television, delivered information is delivered as broadcasting through the airwaves. The display device 11 displays an advertisement included in delivered information. Further, the display device 11 includes a built-in short-distance communication unit 22 that performs short-distance wireless communication such as an NFC (Near Field Communication) and the built-in short-distance communication unit 22 readably provides code information included in delivered information. The code information is, for example, a promotion code or a coupon code, which offers an incentive reward when it is provided to a store. It is noted that the delivered information can be provided with a name, such as a promotion name or a coupon name, or an expiration date or the like of the code information.

The portable terminal device 12 is a terminal device carried and kept by a user. The portable terminal device 12 is a cell phone, a smartphone, or a PDA (Personal Digital Assistant), for example. The portable terminal device 12 also has a built-in short-distance communication unit 53 that performs short-distance wireless communication such as an NFC and can read the code information from the display device 11.

The store device 13 is a device located in a store and is a POS (Point Of Sales) terminal used for account processing of the store, for example. Here, the store device 13 can be an information processing device such as a desktop PC, a tablet PC, and a laptop PC. The store device 13 also includes a built-in short-distance communication unit 81 that performs short-distance wireless communication such as an NFC and can read and write code information. The store offers service using the code information. The service using the code information can be providing an incentive reward such as offering points or discounting a price, for example. The present embodiment will be explained by taking an example in which the short-distance communication unit 81 provided in the store device 13 reads reading code and a discount is offered.

When the user refers to an advertisement displayed on the display device 11 and desires to purchase the displayed product, the user places the short-distance communication unit 53 of the portable terminal device 12 close to or contacting with the short-distance communication unit 22 of the display device 11 to communicate so that the portable terminal device 12 reads code information from the display device 11. Then, the user visits a store of the advertiser to purchase the product. In this situation, the user lets the short-distance communication unit 81 of the store device 13 read the code information from the short-distance communication unit 53 of the portable terminal device 12 to receive an incentive reward such as a discount. In the store, reading the code information from the portable terminal device 12 by using the store device 13 helps to recognize the user as a user who has viewed the advertisement. Here, the advertiser providing the advertisement may be different from a business owner of the store. For example, in some cases, an electronics manufacturer advertises as an advertiser and the store devices 13 in various stores such as an electronics retail store handling the advertised product recognizes a user who has viewed the advertisement by reading code information from the portable terminal device 12 and offers incentive rewards. Thus, the advertisement may be an advertisement provided by a store having the store device 13 or an advertisement provided by an advertiser different from the business owner of the store.

1-2. Configurations of Display Device, Portable Terminal Device, and Store Device

Next, the display device 11, the portable terminal device 12, and the store device 13 according to the first embodiment will be further described in detail. Firstly, a configuration of the display device 11 will be described. FIG. 2 is a diagram illustrating an example of a functional configuration of the display device according to the first embodiment.

As illustrated in FIG. 2, the display device 11 includes a receiving unit 20, a display unit 21, the short-distance communication unit 22, and a control unit 23.

The receiving unit 20 is a device to receive information delivered from outside. The receiving unit 20 is connected to an antenna (not illustrated) and receives broadcasting via the antenna. The receiving unit 20 also receives delivered information delivered by broadcasting via the antenna. For example, the receiving unit 20 receives delivered information delivered including a product advertisement and code information that is to be provided to the store of the advertiser advertising the product to offer an incentive reward. In the code information, a name of the code information is added.

The display unit 21 is a display device for displaying various information. As the display unit 21, there is a display device such as an LCD (Liquid Crystal Display) and a CRT (Cathode Ray Tube). The display unit 21 displays various information. For example, the display unit 21 displays content such as an image or the like delivered by broadcast. Further, the display unit 21 displays an advertisement included in delivered information delivered by broadcast.

The short-distance communication unit 22 is a device for performing short-distance wireless communication. The short-distance communication unit 22 is equipped with an IC (Integrated Circuit) chip that is compliant with short-distance wireless communication such as an NFC and, with the IC chip, communicates with other devices compliant with short-distance wireless communication to transmit and receive various data. For example, the short-distance communication unit 22 readably provides code information and a name of the code information included in delivered information and outputs the code information when the short-distance communication unit 53 of the portable terminal device 12 approaches close enough to communicate.

The control unit 23 is a device to control the display device 11. For example, as the control unit 23, an electronic circuit such as a CPU (Central Processing Unit) and an MPU (Micro Processing Unit) or an integrated circuit such as an ASIC (Application Specific Integrated Circuit) and an FPGA (Field Programmable Gate Array) can be used. The control unit 23 includes internal memory to store a program specifying various processing procedures or control data and executes various processes based on them. As various programs operate therein, the control unit 23 functions as various processors. For example, the control unit 23 has a dividing unit 30, a display control unit 31 and a short-distance communication control unit 32.

The dividing unit 30 performs various divisions. For example, the dividing unit 30 divides advertisement data and code information from delivered information.

The display control unit 31 controls display of the display unit 21. For example, the display control unit 31 controls to display, on the display unit 21, the advertisement of the advertisement data divided by the dividing unit 30.

The short-distance communication control unit 32 controls the short-distance communication unit 22. For example, the display control unit 31 sets the code information divided by the dividing unit 30 to the short-distance communication unit 22 and controls the short-distance communication unit 22 to make the code information readable from the outside. With this structure, the short-distance communication unit 22 provides readable code information. Here, the short-distance communication unit 22 may provide readable code information corresponding to the advertisement while an advertisement is being displayed on the display unit 21. For example, in a case that the code information is delivered only when the advertisement is being displayed, the short-distance communication control unit 32 sets the code information to the short-distance communication unit 22 while the code information is delivered. On the other hand, when advertisements are sequentially performed during a delivered show and code information is delivered in the beginning of the respective advertisements, the short-distance communication control unit 32 sets the delivered code information to the short-distance communication unit 22 until another code information is delivered or until the show ends.

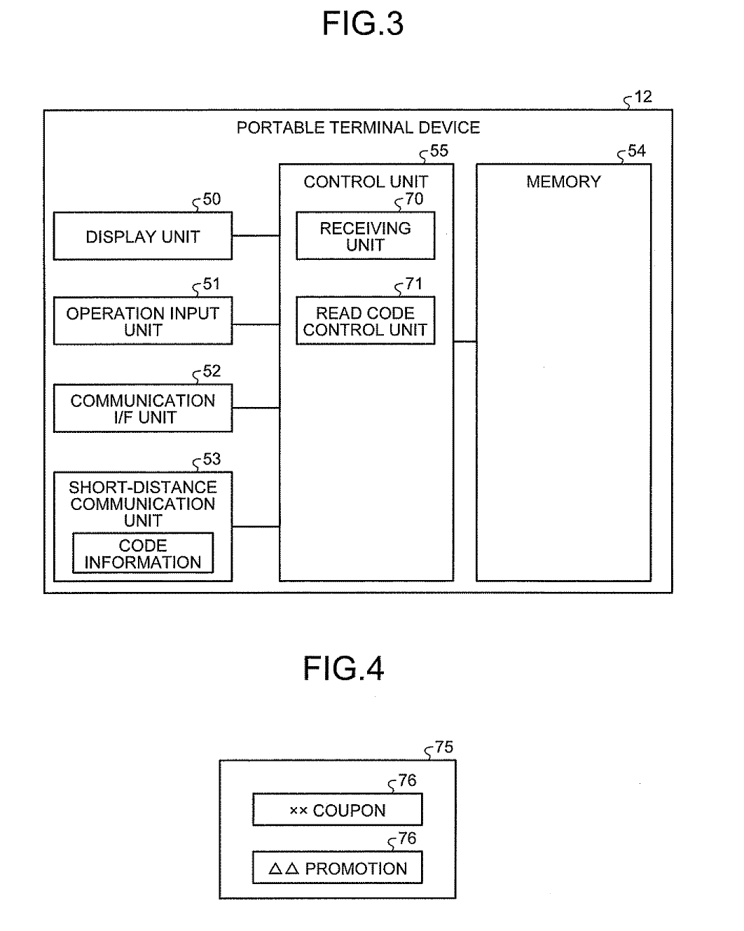

Next, a configuration of the portable terminal device 12 will be described. FIG. 3 is a diagram illustrating an example of a functional configuration of the portable terminal device according to the first embodiment.

As illustrated in FIG. 3, the portable terminal device 12 includes a display unit 50, an operation input unit 51, a communication I/F (interface) unit 52, the short-distance communication unit 53, a memory 54, and a control unit 55. Note that the short-distance communication unit 53 corresponds to a retention unit and an output unit of the present invention.

The display unit 50 is a display device for displaying various information. As the display unit 50, there is a display device such as an LCD. The display unit 50 displays various information. For example, the display unit 50 displays a selecting screen for selecting code information used in a store.

The operation input unit 51 is an input device for inputting various information. For example, the operation input unit 51 can be an input device such as various buttons provided to the portable terminal device 12, a transparent touch sensor provided on the display unit 50, or the like. Here, since the example of FIG. 3 is illustrated as a functional configuration, the display unit 50 and the operation input unit 51 are separately provided; however, a configuration with a device, such as a touch panel, that integrally including the display unit 50 and the operation input unit 51 may be employed. Further, the operation input unit 51 may be a keyboard, a mouse, and the like. The operation input unit 51 receives operation input from the user and inputs the operation information indicating the received operation to the control unit 55.

The communication I/F unit 52 is an interface such as an NIC (Network Interface Card). The communication I/F unit 52 transmits and receives various data to and from other devices via a network.

The short-distance communication unit 53 is a device for performing short-distance wireless communication. The short-distance communication unit 53 is equipped with an IC chip that is compliant with short-distance wireless communication such as an NFC and communicates, using the IC chip, with other devices compliant with short-distance wireless communication to transmit and receive various data. For example, the short-distance communication unit 53, which can read and write code information, reads code information provided from the short-distance communication unit 22 of the display device 11 and retains the read code information. Further, when being able to communicate with the later described short-distance communication unit 81 of the store device 13, the short-distance communication unit 53 outputs the retained code information.

The memory 54 is a device to store various information. For example, as the memory 54, there is a semiconductor memory device such as RAM (Random Access Memory) and flash memory, or a storage device such as a hard disk and an optical disk.

The memory 54 stores an OS (Operating System) executed by the control unit 55, various programs and various data.

The control unit 55 is a device for controlling the portable terminal device 12. For example, as the control unit 55, an electronic circuit such as a CPU and an MPU or an integrated circuit such as an ASIC and an FPGA can be employed. The control unit 55 includes internal memory to store a program specifying various processing procedure or control data and executes various processes based on them. As various programs operate therein, the control unit 55 functions as various processors. For example, the control unit 55 includes a receiving unit 70 and a read code control unit 71.

The receiving unit 70 performs various reception. For example, the display unit 50 displays a selecting screen for selecting code information to be used from code information retained in the short-distance communication unit 53, and the receiving unit 70 receives a designation of code information to be used via the selecting screen.

FIG. 4 is a diagram illustrating an example of the selecting screen according to the first embodiment. As illustrated in FIG. 4, on a selecting screen 75, buttons 76 indicating names of code information retained in the short-distance communication unit 53 are displayed and code information to be used can be designated by selecting the button 76. In the example of FIG. 4, “XX coupon” and “ΔΔ promotion” are selectable as code information. The user selects code information to use from the selecting screen 75 at the store.

The read code control unit 71 controls code information, which is made readable at the store. For example, when code information is designated on the selecting screen 75, the read code control unit 71 controls the short-distance communication unit 53 so that the designated code information is made readable from the outside. The store device 13 reads, via the short-distance communication unit 81, the code information which is made readable this way.

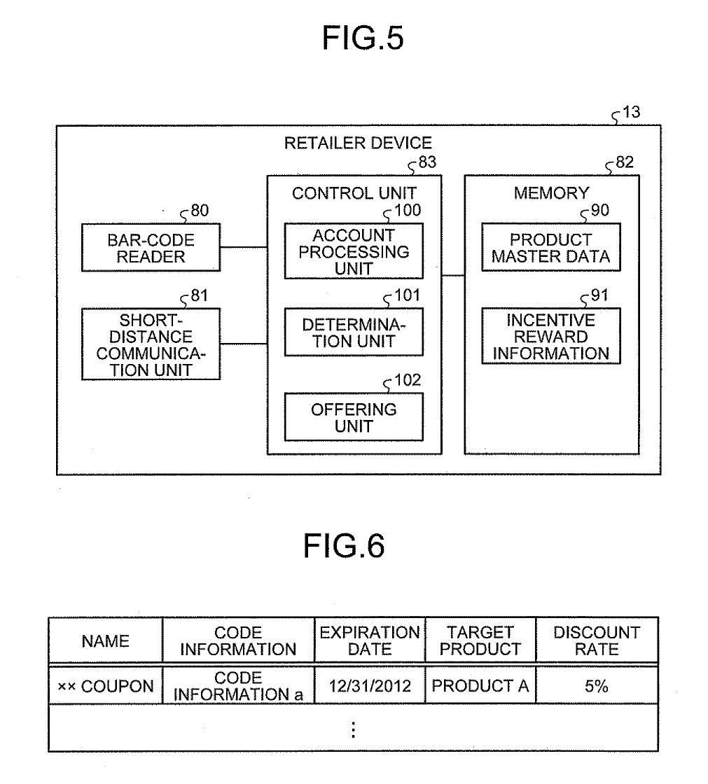

Next, a configuration of the store device 13 will be described. FIG. 5 is a diagram illustrating an example of a functional configuration of the store device according to the first embodiment. As illustrated in FIG. 5, the store device 13 includes a bar-code reader 80, the short-distance communication unit 81, a memory 82, and a control unit 83. Here, the short-distance communication unit 81 corresponds to a receiving unit of the present invention.

The bar-code reader 80 is an interface for reading a product code. For example, the bar-code reader 80 reads a product code of a product which the user purchases by reading the product code recorded in a bar code attached to the product.

The short-distance communication unit 81 is a device for performing short-distance wireless communication. The short-distance communication unit 81 is equipped with an IC chip that is compliant with short-distance wireless communication such as an NFC and communicates, using the IC chip, with other devices compliant with short-distance wireless communication to transmit and receive various data. For example, the short-distance communication unit 81 receives code information from the short-distance communication unit 53 of the portable terminal device 12.

The memory 82 is a device for storing various information. For example, as the memory 82, there is a semiconductor memory device such as RAM (Random Access Memory) and flash memory, or a storage device such as a hard disk and an optical disk.

The memory 82 stores an operating system executed by the control unit 83 or various programs used for delivering advertisements and charging. Further, the memory 82 stores various information. For example, the memory 82 stores product master data 90 and incentive reward information 91.

The product master data 90 is data storing master data related to products. For example, the product master data 90 stores a product name, a price and the like associated with the product code of the product.

The incentive reward information 91 is data storing information related to an incentive reward such as a promotion and a coupon which can be used at the store. For example, the incentive reward information 91 is data storing code information provided as the promotion or coupon, and the name, an expiration date, and a discount rate of the promotion or coupon. For example, the product master data 90 stores the product name and price associated with the product codes of the product.

FIG. 6 is a diagram illustrating an example of a data configuration of the incentive reward information according to the first embodiment. The incentive reward information 91 illustrated in FIG. 6 has an area to store a name, code information, an expiration date, a target product, and a discount rate. The name of code information is stored in the name area of the incentive reward information 91, the code information data is stored in the code information area, the expiration date of the code information is stored in the expiration date area, the discount target product is stored in the target product area, and a discount rate of the code information is stored in the discount rate area. The example of FIG. 6 illustrates that the code information of the “XX coupon” is code information a, the target product area is product A, the expiration date is Dec. 31, 2012, and the discount rate is 5%.

The control unit 83 is a device for controlling the store device 13. For example, as the control unit 83, an electronic circuit such as a CPU and an MPU or an integrated circuit such as an ASIC and an FPGA can be employed. The control unit 83 includes internal memory to store a program specifying various processing procedures or control data and executes various processes based on them. As various programs operate therein, the control unit 83 functions as various processors. For example, the control unit 83 includes an account processing unit 100, a determination unit 101, and an offering unit 102.

The account processing unit 100 performs account processing. For example, based on the product master data 90, the account processing unit 100 performs accounting by obtaining the product name and the price from the product code read by the bar-code reader 80.

The determination unit 101 performs various determinations related to the code information. For example, when the short-distance communication unit 81 receives code information, the determination unit 101 determines whether the received code information is proper code information to offer an incentive reward. The determination unit 101 determines, for example, whether the received code information is registered in the incentive reward information 91.

Further, the determination unit 101 determines whether the code information is before its expiration date. For example, when the code information is registered in the incentive reward information 91, the determination unit 101 determines whether it is before the expiration date.

The offering unit 102 offers various incentive rewards. For example, when the determination unit 101 determines that the code information is proper and it is before its expiration date, the offering unit 102 discounts the price of the discount target product at the discount rate.

In this manner, the store recognizes that the user has viewed the advertisement since the store device 13 reads, from the portable terminal device 12, the code information which is made readable on the advertisement by the display device 11. Further, since the store device 13 can recognize the user who has viewed the advertisement before offering a discount, it is prevented to unfairly offer a discount to a user who has not viewed the advertisement. Further, since the system 10 can recognize the user who has viewed the advertisement by using the store device 13, it is possible to recognize the advertisement effect, that is, what kind of users visit the store because of the advertisement to purchase the product. Since the system 10 can recognize what kind of users visit the store because of the advertisement to purchase the product, it can be used to plan a strategy to make an effective advertisement.

1-3. Operation

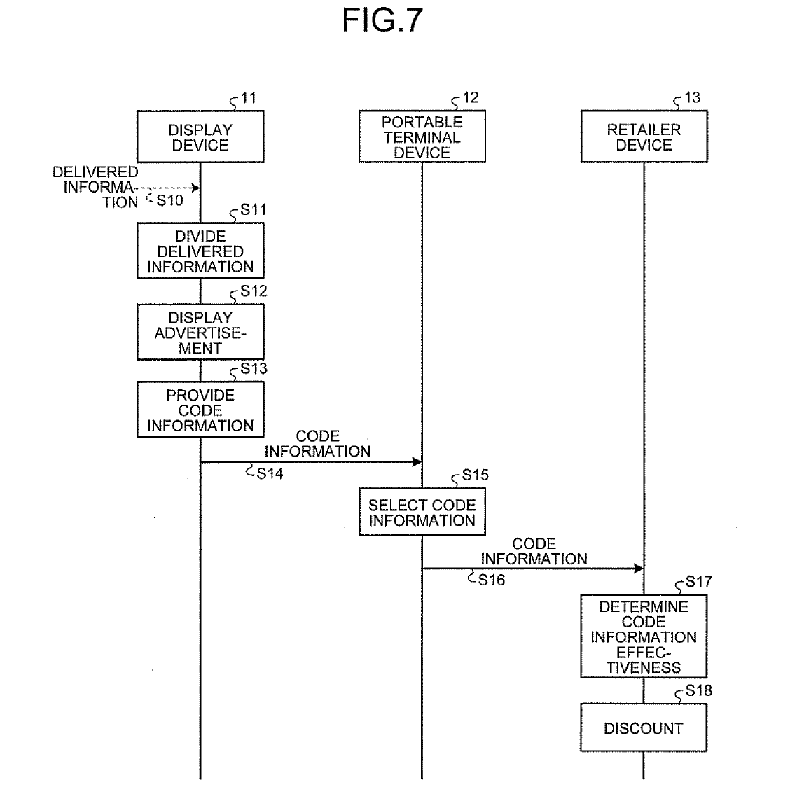

Next, operation of the system 10 according to the present embodiment will be described. FIG. 7 is a sequence diagram illustrating a process flow when the system according to the first embodiment delivers an advertisement and a user who viewed the advertisement purchases the product.

To the display device 11, delivered information including an advertisement of a product and code information for offering an incentive reward related to the product is delivered via an antenna (Step S10). When the delivered information is delivered, the display device 11 divides advertisement data and code information from the delivered information (Step S11). Then, the display device 11 makes the display unit 21 display the advertisement of the divided advertisement data (Step S12) and readably provides the divided code information via the short-distance communication unit 22 (Step S13).

The user refers to the advertisement displayed on the display device 11 and, when desiring to purchase the displayed product, the user places the short-distance communication unit 53 of the portable terminal device 12 close to or contacting with the short-distance communication unit 22 of the display device 11. In this manner, the portable terminal device 12 reads the code information from the display device 11 (Step S14). As described above, since an actual action such as contacting with the display device 11 makes the portable terminal device 12 obtain the code information, it is more certain that the user of the portable terminal device 12 has viewed the advertisement.

When the user visits the store of the advertiser to purchase the product, the user selects code information to use from the portable terminal device 12 (Step S15). Then, the user places the short-distance communication unit 53 of the portable terminal device 12 close to or contacting with the short-distance communication unit 81 of the store device 13. In this manner, the store device 13 reads the code information from the portable terminal device 12 (Step S16). The determination unit 101 of the store device 13 determines whether the read code information is effective (Step S17). The determination unit 101 determines, for example, whether it is registered in the incentive reward information 91 and whether it is before the expiration date. Then, when the code information is effective, the offering unit 102 offers a discount from the price of the discount target product at the discount rate (Step S18).

1-4. Effects

As described above, in the system 10, the display device 11 receives delivered information delivered including an advertisement of a product and code information to be provided to the store of the advertiser of the advertised product to offer an incentive reward, displays the advertisement included in the received delivered information, and readably provides the code information included in the received delivered information. Further, the portable terminal device 12 reads and retain the code information from the display device 11 and outputs the retained code information when being able to communicate with the store device 13. Then, the store device 13 receives the code information output from the portable terminal device 12, determines whether the advertisement identified by the received code information is a certain advertisement, and offers an incentive reward to the user of the portable terminal device 12 when it is the certain advertisement. With this configuration, the system 10 can surely recognize, at the store, the user who visited the store after viewing the advertisement.

Further, an expiration date is specified in the code information, and the store device 13 offers an incentive reward when the code information is written before the expiration date. With this configuration, the system 10 can prevent that an incentive reward is offered based on code information of an old advertisement.

Further, while displaying an advertisement, the display device 11 provides readable code information. The portable terminal device 12 reads code information from the display device 11 by short-distance communication. With this configuration, the system 10 can provide code information to the user viewing the advertisement.

### Second Embodiment

Next, a second embodiment will be described. Since the configurations of a system 10, a display device 11, and a portable terminal device 12 according to the second embodiment are the same as those of the system 10, the display device 11, and the portable terminal device 12 according to the first embodiment illustrated in FIG. 1, those explanations are omitted.

2-1. Configuration of Portable Terminal Device and Store Device

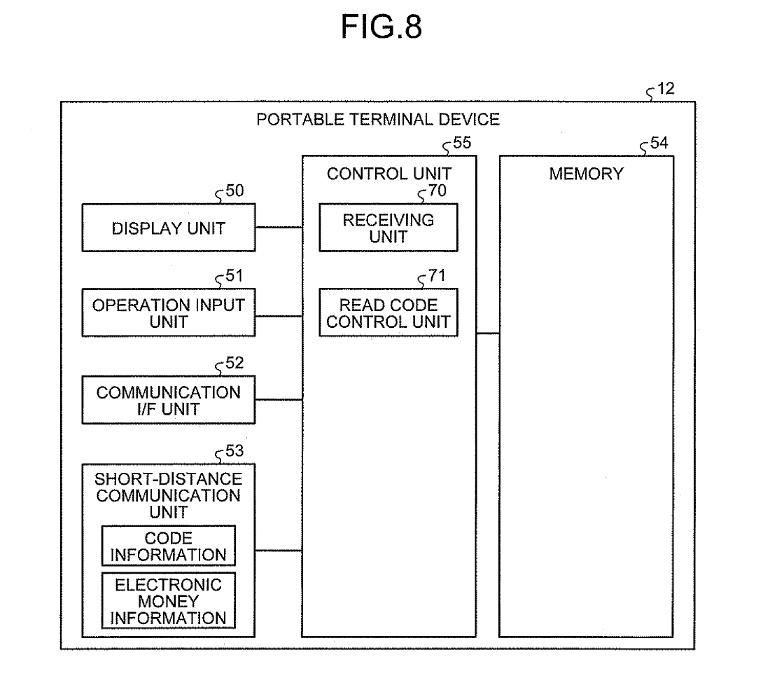

FIG. 8 is a diagram illustrating an example of a functional configuration of the portable terminal device according to the second embodiment. Since the configuration of the portable terminal device 12 according to the second embodiment is substantially the same as the portable terminal device 12 according to the first embodiment illustrated in FIG. 2, different parts will mainly be explained.

As illustrated in FIG. 8, the short-distance communication unit 53 further retains electronic money information storing a money value as digital data. Here, the electronic money information can be either of a prepaid type or an after-payment type. The short-distance communication unit 53 outputs code information together with the electronic money information when a payment is settled using electronic money stored as the electronic money information. Here, the short-distance communication unit 53 corresponds to a settlement unit of the present invention.

When a payment of an advertised product is settled with the store device, the user places the short-distance communication unit 53 of the portable terminal device 12 close to or contacting with the short-distance communication unit 81 of the store device 13. In this manner, the short-distance communication unit 81 and the short-distance communication unit 53 of the portable terminal device 12 communicate related to the electronic money and the store device 13 settles the payment using the electronic money. Further, when the portable terminal device 12 makes payment of the advertised product with the store device 13, the short-distance communication unit 81 receives the code information from the short-distance communication unit 53 of the portable terminal device 12 and, when the received code information is effective and before the expiration date, an incentive reward such as a discount of the advertised product is offered.

2-2. Effects

As described above, in the system 10, the portable terminal device 12 is able to settle a payment via the short-distance communication unit 53. When the payment of the advertised product is settled with the store device 13 via the short-distance communication unit 53, the store device 13 receives code information from the portable terminal device 12. In this manner, the system 10 can offer an incentive reward when the payment of the advertised product is settled.

### 3. Others

Although some of embodiments of the present invention are descried above in detail with reference to the drawings, they are only examples and the present invention can be executed in other embodiments with various modifications and improvements in addition to the manners described in Detailed Description of the Preferred Embodiment.

For example, the above embodiments describe a case that effective code information is stored in the store device 13; however, the present invention is not limited to this case. For example, it can be made that a determination rule of effective code information is stored in the store device 13 and the store device 13 determines whether the received code information is a code satisfying the determination rule.

Further, the above embodiments describe a case in which the discount target product, discount rate, and effective period are stored in the store device 13; however, the present invention is not limited to this case. For example, it can be made that the discount target product, discount rate, and effective period are added to the code information and transmitted to the store device 13 from the display device 11 via the portable terminal device 12 by short-distance wireless communication. With this configuration, the store device 13 can offer a discount of the product using only the code information and the discount target product, discount rate, and effective period do not have to be stored in the incentive reward information 91 in advance.

Further, the above embodiments describe a case in which, in the portable terminal device 12, the code information read from the display device 11 is stored in the short-distance communication unit 53 and the code information to be used is selected on the selecting screen 75; however, the present invention is not limited to this case. For example, it can be made that all code information stored in the short-distance communication unit 53 of the portable terminal device 12 is made readable and the store device 13 reads the all code information and determines whether the each code information is effective. Further, for example, it can be made that the code information includes retailer information related to target stores and the store device 13 reads only code information related to the own store.

Further, the above embodiments describe a case in which the portable terminal device 12 reads code information related to the advertisement from the display device 11 and the store device 13 reads the code information from the portable terminal device 12; however, the present invention is not limited to this case. For example, the portable terminal device 12 or the store device 13 may read the code information together with other information. For example, the portable terminal device 12 may store information related to the user such as the user's age, sex, address or the like and the store device 13 may read the information related to the user together with the code information. The store device 13 may read a part of the information related to the user such as user's sex or age. Further, the code information may include specification information that specifies the information related to the user to be provided to the store device 13, the portable terminal device 12 may readably provide the information related to the user specified by the specification information together with the code information, and the store device 13 may read the information related to the user specified by the specification information together with the code information. With this configuration, since the system 10 can recognize what type of user has viewed the advertisement and visited the store, this helps to examine the effects of the advertisement and define more specific target to advertise.

Further, the “unit” described in the claims can also be understood as a “section,” a “module,” or a “circuit.” For example, a “search unit” can be understood also as a “search section” or a “search circuit.”

In an advertising system according to the present application, it is possible to surely recognize, at the store, a user who viewed the advertisement before visiting the store.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertising system comprising a portable terminal device configured to read and output information and a store device configured to receive the information output from the portable terminal device, wherein
the portable terminal device comprises:
a retention unit that reads and retains a code information output from a display device that displays an advertisement of a product included in delivered information and outputs the code information which can identify the advertisement included in the delivered information; and
an output unit that outputs the code information when being communicable with the store device, and
the store device comprises:
a determination unit that receives the code information output from the portable terminal device and determines whether the advertisement identified by the code information is a certain advertisement; and
an adding unit that offers an incentive reward to a user of the portable terminal device when the determination result by the determination unit is that it is a certain advertisement.

2. The advertising system according to claim 1, wherein
an expiration date is set to the code information, and
the adding unit offers the incentive reward when the code information is received before the expiration date.

3. The advertising system according to claim 1, wherein
the code information is output from the display device while the advertisement is displayed on the display device.

4. The advertising system according to claim 1, wherein
the portable terminal device reads the code information from the display device by short-distance communication.

5. The advertising system according to claim 1, wherein
the advertisement is an advertisement provided by a store which has the store device.

6. The advertising system according to claim 1, wherein
the advertisement is of a predetermined advertiser, and
the store device offers the incentive reward when the advertisement is an advertisement of a predetermined advertiser.

7. The advertising system according to claim 1, wherein
the portable terminal device comprises a settlement unit and, when a payment of the product of the advertisement is settled with the store device via the settlement unit, the store device receives the code information from the portable terminal device.

8. An advertising method comprising a portable terminal device configured to read and output information and a store device configured to receive the information output from the portable terminal device, comprising the steps of:
in the portable terminal device,
reading and retaining the code information output from a display device that displays an advertisement of a product included in delivered information and outputs code information which can identify the advertisement included in the delivered information, and
outputting the retained code information when communicable with the store device, and
in the store device,
receiving the code information output from the portable terminal device and determines whether the advertisement identified by the received code information is a certain advertisement, and
offering an incentive reward to a user of the portable terminal device when the determination result is that it is the certain advertisement.
